(19) United States
(12) Patent Application Publication
(10) Pub. No.: US 2011/0276504 A1
(43) Pub. Date: Nov. 10, 2011

(54) METHODS AND APPARATUS FOR PROVIDING REMUNERATION FOR ADVOCACY

(75) Inventors: Anantha Pradeep, Berkeley, CA (US); Robert T. Knight, Berkeley, CA (US); Ramachandran Gurumoorthy, Berkeley, CA (US); Thomas Robbins, Berkeley, CA (US)

(73) Assignee: NEUROFOCUS, INC., Berkeley, CA (US)

(21) Appl. No.: 13/104,840

(22) Filed: May 10, 2011

Related U.S. Application Data
(60) Provisional application No. 61/332,887, filed on May 10, 2010.

(51) Int. Cl. G06Q 30/00

(52) U.S. Cl. 705/319

(57) ABSTRACT

Users in a social networking environment are matched with subjects of advocacy, such as products, services, offers, candidates, etc., by evaluating user profile characteristic information. The user may provide advocacy materials and an advocacy system may also generate advocacy materials that may be incorporated with the user's own testimonials. The advocacy materials are distributed using social network channels. A remuneration tracking system monitors distribution of the advocacy materials and analyzes metrics to determine the effectiveness of the distribution. In some examples, the renumeration tracking system monitors redistribution of the advocacy materials, purchase or selection of an offer upon viewing the advocacy materials, and/or commenting or positively valuing the advocacy materials.

### CROSS-REFERENCE TO RELATED APPLICATION

This application claims the benefit under 35 U.S.C. §119(e) to U.S. Provisional Application 61/332,887 (NFCSP045P) titled “METHODS AND APPARATUS FOR PROVIDING REMUNERATION FOR ADVOCACY,” filed May 10, 2010, all of which is incorporated herein by this reference in its entirety.

### TECHNICAL FIELD

The present disclosure relates to providing remunderation for advocacy.

### DESCRIPTION OF RELATED ART

Conventional mechanisms for advertising in social networking environments are limited. Advertisements may be selected based on user profile characteristics and placed along side user feeds. Advertisements may include text, graphics, audio, etc. However, many advertisements are not extremely effective. Mechanisms for selection, purchase, customization, and placement of advertisements from various sources into advertisements slots available in social networking environments are limited. Conventional systems are subject to inefficiencies, as advertisers can not effectively determine the most efficient mechanisms for presenting their advertisements.

Consequently, it is desirable to provide improved methods and apparatus for incentivizing the promotion of brands, products, services, and offers in social networking environments.

### BRIEF DESCRIPTION OF THE DRAWINGS

The disclosure may best be understood by reference to the following description taken in conjunction with the accompanying drawings, which illustrate particular example embodiments.

FIG. 1 illustrates one example of a system for implementing advocacy as advertisement in a social networking environment.

FIG. 2 illustrates an example of a system for obtaining advocacy characteristics.

FIG. 3 illustrates examples of data models that can be used with a stimulus and response repository.

FIG. 4 illustrates one example of a query that can be used with the advertisement exchange.

FIG. 5 illustrates one example of a report generated using the advertisement exchange.

FIG. 6 illustrates one example of a technique for performing data analysis.

FIG. 7 illustrates one example of technique for advocacy system implementation.

FIG. 8 provides one example of a system that can be used to implement one or more mechanisms.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular types of advocacy. However, it should be noted that some of the techniques and mechanisms can be applied to a variety of different types of advocacy and endorsement. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

Users in a social networking environment are matched with subjects of advocacy, such as products, services, offers, candidates, etc., by evaluating user profile characteristic information. The user may provide advocacy materials and an advocacy system may also generate advocacy materials that may be incorporated with the user's own testimonials. The advocacy materials are distributed using social network channels. A remuneration tracking system monitors distribution of the advocacy materials and analyzes metrics to determine the effectiveness of the distribution. In some examples, the renumeration tracking system monitors redistribution of the advocacy materials, purchase or selection of an offer upon viewing the advocacy materials, and/or commenting or positively valuing the advocacy materials.

### Example Embodiments

Conventional mechanisms for advertising in social networking environments involves targeting advertisements to those perceived to be potentially interested in the subject of the advertisements. In some instances, celebrity endorsers are retained to advocate for a particular product. The celebrity endorser may have a higher level of influence over particular members of an audience than a generic advertisement. However, celebrity endorsers themselves may not have sufficient influence over particular memers of a community. Consequently, the techniques and mechanisms of the present invention contemplate using social network members themselves to advocate or endorse particular brands, products, services, and/or offers. These brands, products, services, offers, etc., are referred to herein as subjects of advocacy.

Mechanisms are provided for selecting the most appropriate subjects of advocacy for advocates. According to various embodiments, advocates select subjects of advocacy. In particular embodiments, advocates choose from a set of pre-selected subjects of advocacy. In other embodiments, advocates are selected by entities seeking to promote goods, services, etc. The subjects of advocacy may be pre-selected for the advocate based on the advocates own profile information and the profile information of the users in the advocates social network. For example, an advocate having mostly 35-45 year old college graduates would have particular subjects of advocacy selected for that target group.

The advocate can then generate their own materials for advocating the subject of advocacy or materials can be automatically generated for the advocate using information from a product, service, offer, and/or brand source. The content can then be presented by the advocate to users on the social network. The advocate may be compensated for presenting a subject of advocacy. In some examples, credits are provided to the advocate based on the amount of downstream distribution of the endorsement to 2nd degree members of the social network. In particular embodiments, credits are provided based on the number of “likes” attached to the generated advocacy materials.

According to various embodiments, the techniques and mechanisms of the present invention may use a variety of mechanisms such as survey based responses, statistical data, and demographic data to improve endrosement target matching and endorsement distribution. Advocacy materials may be neurophysiologically analyzed

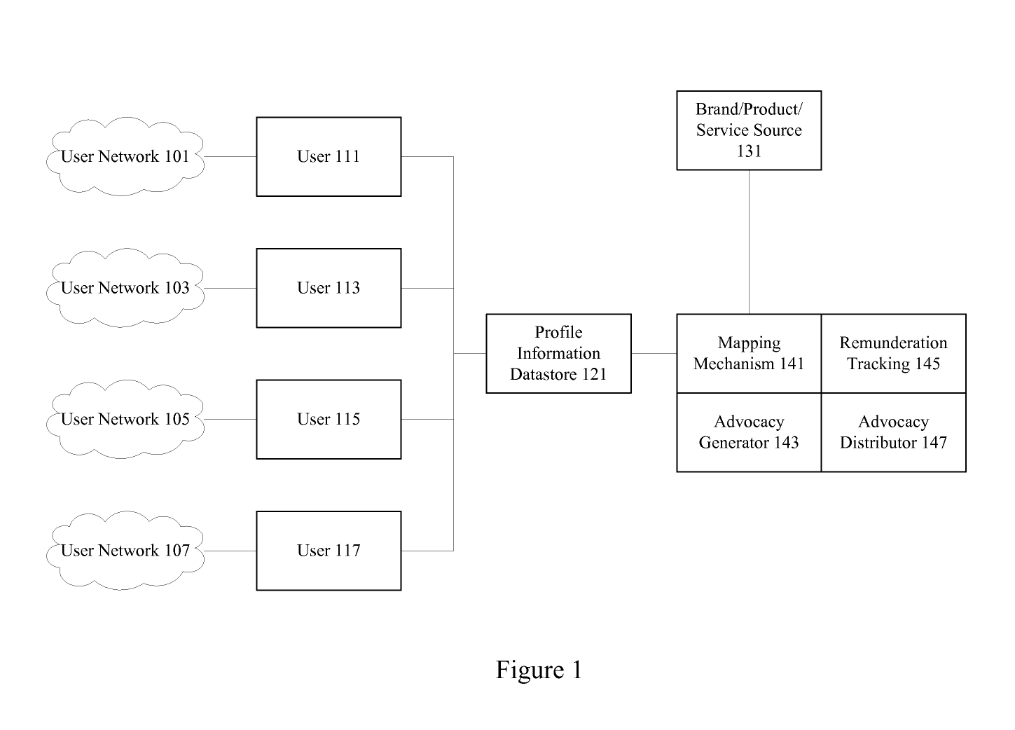

FIG. 1 illustrates one example of a system for generating advocacy as advertisement. Users 111, 113, 115, and 117 have corresponding social networks 101, 103, 105, and 107. Users 111, 113, 115, and 117 provide information to a profile information datastore 121. The profile information datastore 121 may receive demographic information, activity and interest information, socioeconomic status data, etc., about the users 111, 113, 115, and 117 as well as members of the corresponding social networks. User may opt in to be profiled for potential advocacy opportunities. According to various embodiments, users indicate their brand and product preferences and these preferences are maintained in the profile information datastore 121. In particular embodiments, group memberships and user news feeds can be mined for interest areas, life states, skill sets, purchases, etc. Profile information about members of corresponding social networks can be used to enhance the data set associated with users 111, 113, 115, and 117.

The profile information datastore 121 is connected to a mapping mechanism 141. The mapping mechanism 141 receives potential subjects of advocacy such as brands, products, services, and offers, from sources such as companies, individuals, firms, etc. According to various embodiments, these sources identify characteristics of advocates that they would like to retain. In other examples, neurophysiological data and survey data can be used to identify profile characteristics of suitable advocates. In still other examples, advocates select brands, products, and services that they would like to endorse.

An advocacy generator 143 allows a user to prepare materials to advocate for a particular products, service, offer, etc., but also can automatically generate materials for advocates to include in their testimonials and endorsements. According to various embodiments, the materials are generated using neurophysiologically analyzed components that are effective for particular members of the advocate's social network. Advocacy materials may include text, audio, video, etc., and may incorporate advocate testimonials, use caess, commentary, and anecdotes. In particular embodiments, advocacy materials generated are a combination of neurophysiologically analyzed components and advocate generated materials.

Remuneration tracker 145 can be used to identify advocacy efforts and provide credits to the advocate. According to various embodiments, the remunderation tracker 145 monitors the distribution of advocacy materials, follow-up advocacy materials, and redistribution of the advocacy materials by members of an advocate's social network. The number of redistributions may be used to identify the number of credits to be provided to the advocate. In other examples, the number of social network members who indicate that the advocacy is valued or liked is monitored. In still other examples, the number of social network members who accept an offer or purchase a good or service is monitored in order to compensate the advocate.

According to various embodiments, an advocacy distributor 147 allows an advocate to present advocacy materials to social network members. The advocacy materials may be presented to friends/family/followers, or to community members, affinity groups, or interest groups. In particular embodiments, the materials can also be presented to a broader audience. The advocacy materials can also be archived by meta-tagging, inclusion in a user or community profile, etc. In particular embodiments, advocacy materials may be further propagated by members of corresponding social networks.

According to various embodiments, no neurophysiological analysis needs to be performed. However, the profile information datastore 121, mapping mechanism 141, and advocacy generator 143 can all be analyzed for effectiveness using neuro-response data.

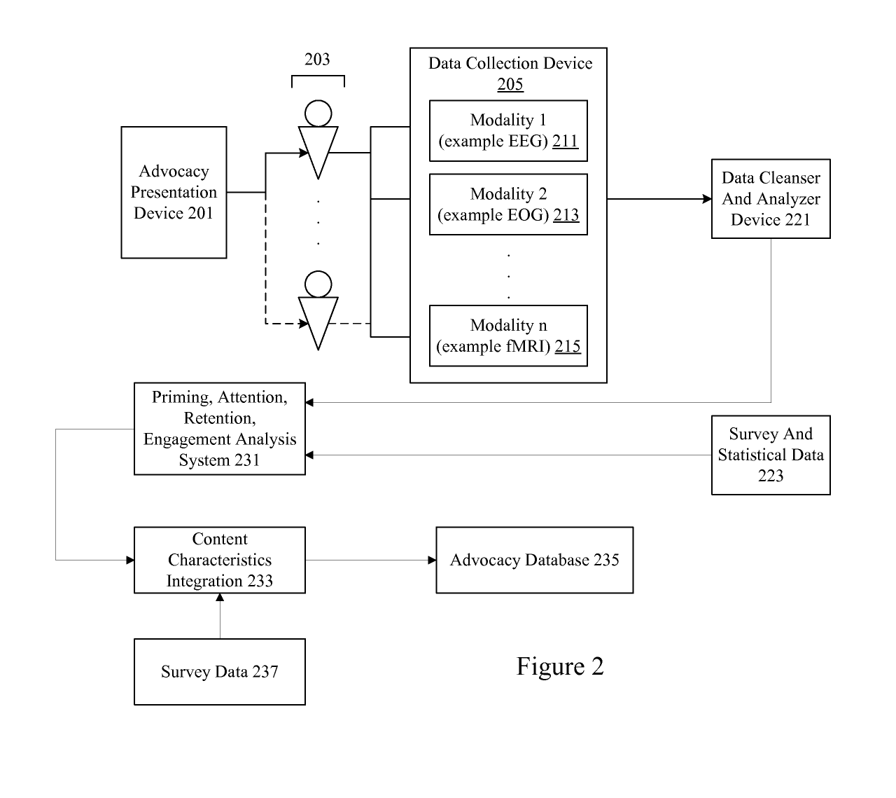

FIG. 2 illustrates one example of a system for analyzing neuro-response data. According to various embodiments, the system includes an advocacy presentation device 201. According to various embodiments, the advocacy presentation device 201 is merely a display, monitor, screen, etc., that displays stimulus material to a user. The stimulus material may be a media clip, a commercial, pages of text, a brand image, a performance, a magazine advertisement, a movie, an audio presentation, an advertisement, a banner ad, commercial, and may even involve particular tastes, smells, textures and/or sounds. The stimuli can involve a variety of senses and occur with or without human supervision. Continuous and discrete modes are supported. According to various embodiments, the advocacy presentation device 201 also has protocol generation capability to allow intelligent customization of stimuli provided to multiple subjects in different markets.

According to various embodiments, advocacy presentation device 201 could include devices such as televisions, cable consoles, computers and monitors, projection systems, display devices, speakers, tactile surfaces, etc., for presenting the stimuli including but not limited to advertising and entertainment from different networks, local networks, cable channels, syndicated sources, websites, internet content aggregators, portals, service providers, etc.

According to various embodiments, the subjects 203 are connected to data collection devices 205. The data collection devices 205 may include a variety of neuro-response measurement mechanisms including neurological and neurophysiological measurements systems such as EEG, EOG, FMRI, EKG, pupillary dilation, eye tracking, facial emotion encoding, and reaction time devices, etc. According to various embodiments, neuro-response data includes central nervous system, autonomic nervous system, and effector data. In particular embodiments, the data collection devices 205 include EEG 211, EOG 213, and FMRI 215. In some instances, only a single data collection device is used. Data collection may proceed with or without human supervision.

The data collection device 205 collects neuro-response data from multiple sources. This includes a combination of devices such as central nervous system sources (EEG), autonomic nervous system sources (FMRI, EKG, pupillary dilation), and effector sources (EOG, eye tracking, facial emotion encoding, reaction time). In particular embodiments, data collected is digitally sampled and stored for later analysis. In particular embodiments, the data collected could be analyzed in real-time. According to particular embodiments, the digital sampling rates are adaptively chosen based on the neurophysiological and neurological data being measured.

In one particular embodiment, the advertisement exchange includes EEG 211 measurements made using scalp level electrodes, EOG 213 measurements made using shielded electrodes to track eye data, FMRI 215 measurements performed using a differential measurement system, a facial muscular measurement through shielded electrodes placed at specific locations on the face, and a facial affect graphic and video analyzer adaptively derived for each individual.

In particular embodiments, the data collection devices are clock synchronized with an advocacy presentation device 201. In particular embodiments, the data collection devices 205 also include a condition evaluation subsystem that provides auto triggers, alerts and status monitoring and visualization components that continuously monitor the status of the subject, data being collected, and the data collection instruments. The condition evaluation subsystem may also present visual alerts and automatically trigger remedial actions. According to various embodiments, the data collection devices include mechanisms for not only monitoring subject neuro-response to stimulus materials, but also include mechanisms for identifying and monitoring the stimulus materials. For example, data collection devices 205 may be synchronized with a set-top box to monitor channel changes. In other examples, data collection devices 205 may be directionally synchronized to monitor when a subject is no longer paying attention to stimulus material. In still other examples, the data collection devices 205 may receive and store stimulus material generally being viewed by the subject, whether the stimulus is a program, a commercial, printed material, or a scene outside a window. The data collected allows analysis of neuro-response information and correlation of the information to actual stimulus material and not mere subject distractions.

According to various embodiments, the advertisement exchange also includes a data cleanser device 221. In particular embodiments, the data cleanser device 221 filters the collected data to remove noise, artifacts, and other irrelevant data using fixed and adaptive filtering, weighted averaging, advanced component extraction (like PCA, ICA), vector and component separation methods, etc. This device cleanses the data by removing both exogenous noise (where the source is outside the physiology of the subject, e.g. a phone ringing while a subject is viewing a video) and endogenous artifacts (where the source could be neurophysiological, e.g. muscle movements, eye blinks, etc.).

The artifact removal subsystem includes mechanisms to selectively isolate and review the response data and identify epochs with time domain and/or frequency domain attributes that correspond to artifacts such as line frequency, eye blinks, and muscle movements. The artifact removal subsystem then cleanses the artifacts by either omitting these epochs, or by replacing these epoch data with an estimate based on the other clean data (for example, an EEG nearest neighbor weighted averaging approach).

According to various embodiments, the data cleanser device 221 is implemented using hardware, firmware, and/or software. It should be noted that although a data cleanser device 221 is shown located after a data collection device 205 and before content characteristics integration 233, the data cleanser device 221 like other components may have a location and functionality that varies based on system implementation. For example, some systems may not use any automated data cleanser device whatsoever while in other systems, data cleanser devices may be integrated into individual data collection devices.

In particular embodiments, an optional survey and interview system collects and integrates user survey and interview responses to combine with neuro-response data to more effectively select content for delivery. According to various embodiments, the survey and interview system obtains information about user characteristics such as age, gender, income level, location, interests, buying preferences, hobbies, etc. The survey and interview system can also be used to obtain user responses about particular pieces of stimulus material.

According to various embodiments, the priming repository system 231 associates meta-tags with various temporal and spatial locations in program content and provides these meta-tags to an advertisement characteristics database associated with an advertisement exchange. In some examples, commercial or advertisement breaks are provided with a set of meta-tags that identify commercial or advertising content that would be most suitable for a particular advertisement slot. The slot may be a particular position in a commercial pod or a particular location on a page.

Each slot may identify categories of products and services that are primed at a particular point in a cluster. The content may also specify the level of priming associated with each category of product or service. For example, a first commercial may show an old house and buildings. Meta-tags may be manually or automatically generated to indicate that commercials for home improvement products would be suitable for a particular advertisement slot or slots following the first commercial.

In some instances, meta-tags may include spatial and temporal information indicating where and when particular advertisements should be placed. For example, a page that includes advertisements about pet adoptions may indicate that a banner advertisement for pet care related products may be suitable. The advertisements may be separate from a program or integrated into a program. According to various embodiments, the priming repository system 231 also identifies scenes eliciting significant audience resonance to particular products and services as well as the level and intensity of resonance. The information in the priming repository system 231 may be manually or automatically generated and may be associated with other characteristics such as retention, attention, and engagement characteristics. In some examples, the priming repository system 231 has data generated by determining resonance characteristics for temporal and spatial locations in various programs, games, commercial pods, pages, etc.

The information from a priming, attention, engagement, and retention repository system 231 may be combined along with type, demographic, time, and modality information using a content characteristics integration system 233. According to various embodiments, the content characteristics integration system weighs and combines components of priming, attention, engagement, retention, personalization, demographics, etc. to allow selection, purchase, and placement of advertising in effective advertisement slots. The material may be marketing, entertainment, informational, etc.

In particular embodiments, neuro-response preferences are blended with conscious, indicated, and/or inferred user preferences to select neurologically effective advertising for presentation to the user. In one particular example, neuro-response data may indicate that beverage advertisements would be suitable for a particular advertisement break. User preferences may indicate that a particular viewer prefers diet sodas. An advertisement for a low calorie beverage may be selected and provided to the particular user. According to various embodiments, a set of weights and functions use a combination of rule based and fuzzy logic based decision making to determine the areas of maximal overlap between the priming repository system and the personalization repository system. Clustering analysis may be performed to determine clustering of priming based preferences and personalization based preferences along a common normalized dimension, such as a subset or group of individuals. In particular embodiments, a set of weights and algorithms are used to map preferences in the personalization repository to identified maxima for priming.

According to various embodiments, the advertisement exchange includes a data analyzer associated with the data cleanser 221. The data analyzer uses a variety of mechanisms to analyze underlying data in the system to determine resonance. According to various embodiments, the data analyzer customizes and extracts the independent neurological and neuro-physiological parameters for each individual in each modality, and blends the estimates within a modality as well as across modalities to elicit an enhanced response to the presented stimulus material. In particular embodiments, the data analyzer aggregates the response measures across subjects in a dataset.

According to various embodiments, neurological and neuro-physiological signatures are measured using time domain analyses and frequency domain analyses. Such analyses use parameters that are common across individuals as well as parameters that are unique to each individual. The analyses could also include statistical parameter extraction and fuzzy logic based attribute estimation from both the time and frequency components of the synthesized response.

In some examples, statistical parameters used in a blended effectiveness estimate include evaluations of skew, peaks, first and second moments, distribution, as well as fuzzy estimates of attention, emotional engagement and memory retention responses.

According to various embodiments, the data analyzer may include an intra-modality response synthesizer and a cross-modality response synthesizer. In particular embodiments, the intra-modality response synthesizer is configured to customize and extract the independent neurological and neurophysiological parameters for each individual in each modality and blend the estimates within a modality analytically to elicit an enhanced response to the presented stimuli. In particular embodiments, the intra-modality response synthesizer also aggregates data from different subjects in a dataset.

According to various embodiments, the cross-modality response synthesizer or fusion device blends different intra-modality responses, including raw signals and signals output. The combination of signals enhances the measures of effectiveness within a modality. The cross-modality response fusion device can also aggregate data from different subjects in a dataset.

According to various embodiments, the data analyzer also includes a composite enhanced effectiveness estimator (CEEE) that combines the enhanced responses and estimates from each modality to provide a blended estimate of the effectiveness. In particular embodiments, blended estimates are provided for each exposure of a subject to stimulus materials. The blended estimates are evaluated over time to assess resonance characteristics. According to various embodiments, numerical values are assigned to each blended estimate. The numerical values may correspond to the intensity of neuro-response measurements, the significance of peaks, the change between peaks, etc. Higher numerical values may correspond to higher significance in neuro-response intensity. Lower numerical values may correspond to lower significance or even insignificant neuro-response activity. In other examples, multiple values are assigned to each blended estimate. In still other examples, blended estimates of neuro-response significance are graphically represented to show changes after repeated exposure.

According to various embodiments, a data analyzer passes data to a resonance estimator that assesses and extracts resonance patterns. In particular embodiments, the resonance estimator determines entity positions in various stimulus segments and matches position information with eye tracking paths while correlating saccades with neural assessments of attention, memory retention, and emotional engagement. In particular embodiments, the resonance estimator stores data in the priming repository system. As with a variety of the components in the system, various repositories can be co-located with the rest of the system and the user, or could be implemented in remote locations.

Data from various sources including survey based data 237 may be blended and passed to an advocacy database 235. In some examples, survey based data 237 and demographic data may be used without neuro-response data. According to various embodiments, the advocacy database 235 maintains advocacy materials such as printed testimonials, endorsements, etc., and identifies the effectiveness of the advocacy materials for various target audiences.

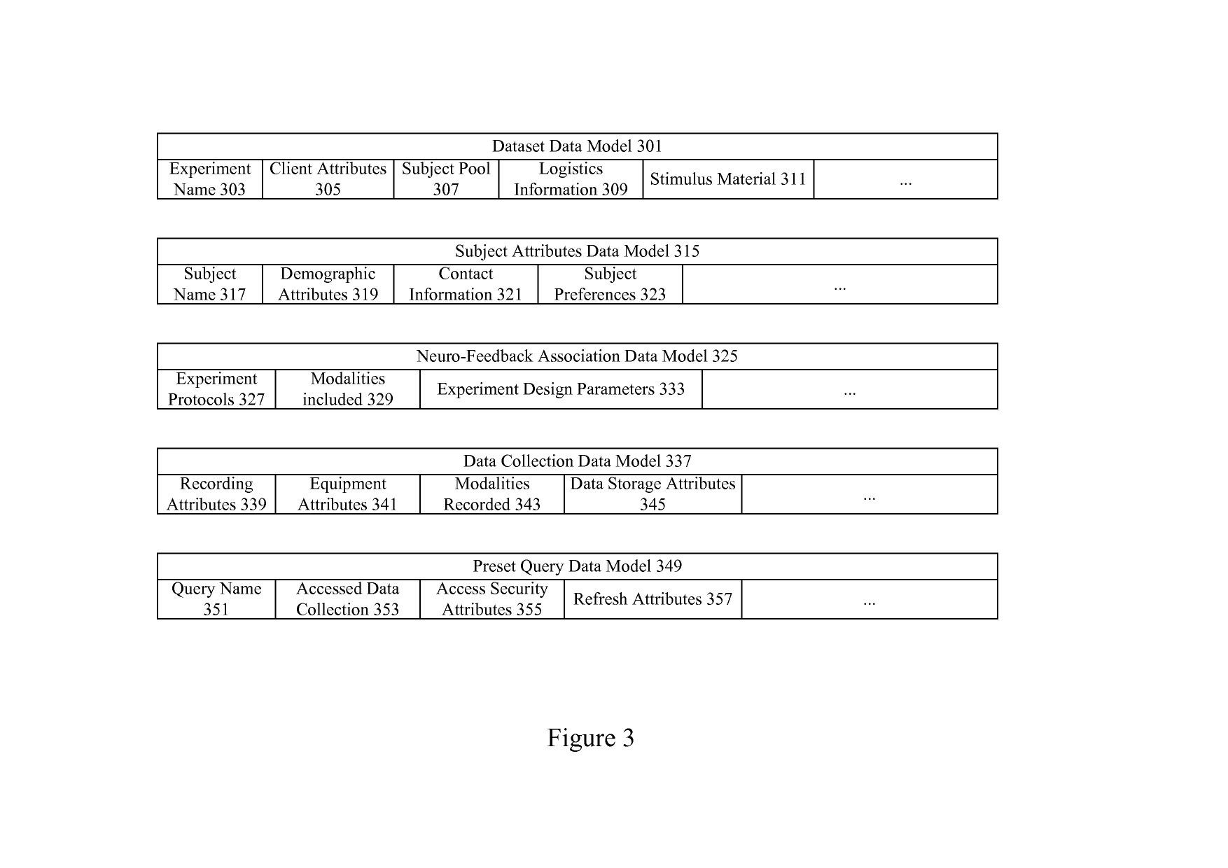

FIG. 3 illustrates examples of data models that can be used for storage of information. According to various embodiments, a dataset data model 301 includes an experiment name 303 and/or identifier, client attributes 305, a subject pool 307, logistics information 309 such as the location, date, and time of testing, and stimulus material 311 including stimulus material attributes.

In particular embodiments, a subject attribute data model 315 includes a subject name 317 and/or identifier, contact information 321, and demographic attributes 319 that may be useful for review of neurological and neuro-physiological data. Some examples of pertinent demographic attributes include marriage status, employment status, occupation, household income, household size and composition, ethnicity, geographic location, sex, race. Other fields that may be included in data model 315 include subject preferences 323 such as shopping preferences, entertainment preferences, and financial preferences. Shopping preferences include favorite stores, shopping frequency, categories shopped, favorite brands. Entertainment preferences include network/cable/satellite access capabilities, favorite shows, favorite genres, and favorite actors. Financial preferences include favorite insurance companies, preferred investment practices, banking preferences, and favorite online financial instruments. A variety of product and service attributes and preferences may also be included. A variety of subject attributes may be included in a subject attributes data model 315 and data models may be preset or custom generated to suit particular purposes.

According to various embodiments, data models for neuro-feedback association 325 identify experimental protocols 327, modalities included 329 such as EEG, EOG, FMRI, surveys conducted, and experiment design parameters 333 such as segments and segment attributes. Other fields may include experiment presentation scripts, segment length, segment details like stimulus material used, inter-subject variations, intra-subject variations, instructions, presentation order, survey questions used, etc. Other data models may include a data collection data model 337. According to various embodiments, the data collection data model 337 includes recording attributes 339 such as station and location identifiers, the data and time of recording, and operator details. In particular embodiments, equipment attributes 341 include an amplifier identifier and a sensor identifier.

Modalities recorded 343 may include modality specific attributes like EEG cap layout, active channels, sampling frequency, and filters used. EOG specific attributes include the number and type of sensors used, location of sensors applied, etc. Eye tracking specific attributes include the type of tracker used, data recording frequency, data being recorded, recording format, etc. According to various embodiments, data storage attributes 345 include file storage conventions (format, naming convention, dating convention), storage location, archival attributes, expiry attributes, etc.

A preset query data model 349 includes a query name 351 and/or identifier, an accessed data collection 353 such as data segments involved (models, databases/cubes, tables, etc.), access security attributes 355 included who has what type of access, and refresh attributes 357 such as the expiry of the query, refresh frequency, etc. Other fields such as push-pull preferences can also be included to identify an auto push reporting driver or a user driven report retrieval system.

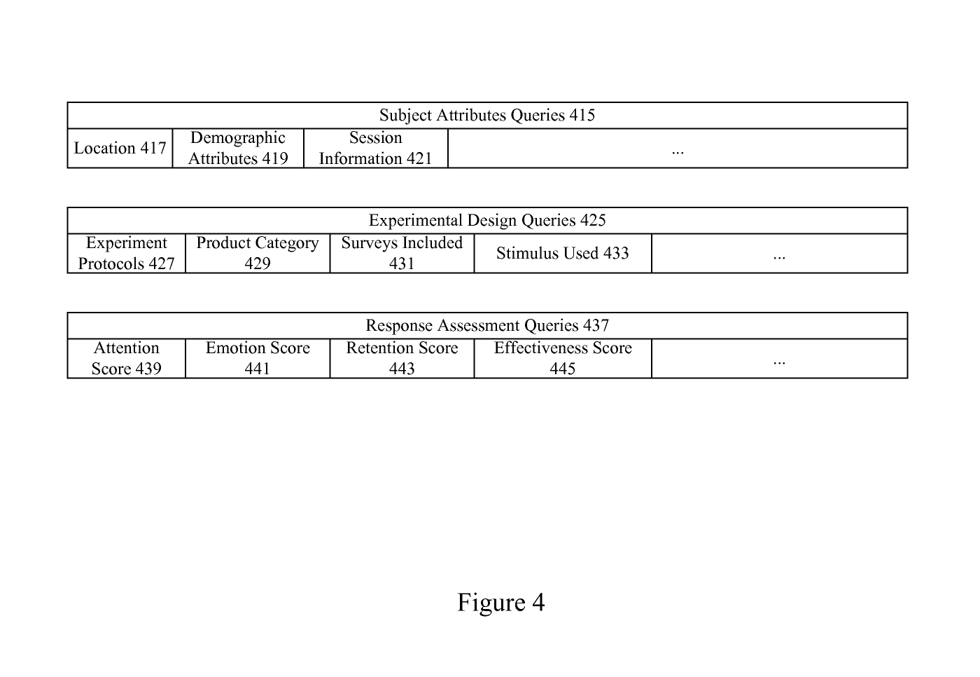

FIG. 4 illustrates examples of queries that can be performed to obtain data. According to various embodiments, queries are defined from general or customized scripting languages and constructs, visual mechanisms, a library of preset queries, diagnostic querying including drill-down diagnostics, and eliciting what if scenarios. According to various embodiments, subject attributes queries 415 may be configured to obtain data from a neuro-informatics repository using a location 417 or geographic information, session information 421 such as testing times and dates, and demographic attributes 419. Demographics attributes include household income, household size and status, education level, age of kids, etc.

Other queries may retrieve stimulus material based on shopping preferences of subject participants, countenance, physiological assessment, completion status. For example, a user may query for data associated with product categories, products shopped, shops frequented, subject eye correction status, color blindness, subject state, signal strength of measured responses, alpha frequency band ringers, muscle movement assessments, segments completed, etc. Experimental design based queries 425 may obtain data from a neuro-informatics repository based on experiment protocols 427, product category 429, surveys included 431, and stimulus provided 433. Other fields that may be used include the number of protocol repetitions used, combination of protocols used, and usage configuration of surveys.

Client and industry based queries may obtain data based on the types of industries included in testing, specific categories tested, client companies involved, and brands being tested. Response assessment based queries 437 may include attention scores 439, emotion scores, 441, retention scores 443, and effectiveness scores 445. Such queries may obtain materials that elicited particular scores.

Response measure profile based queries may use mean measure thresholds, variance measures, number of peaks detected, etc. Group response queries may include group statistics like mean, variance, kurtosis, p-value, etc., group size, and outlier assessment measures. Still other queries may involve testing attributes like test location, time period, test repetition count, test station, and test operator fields. A variety of types and combinations of types of queries can be used to efficiently extract data.

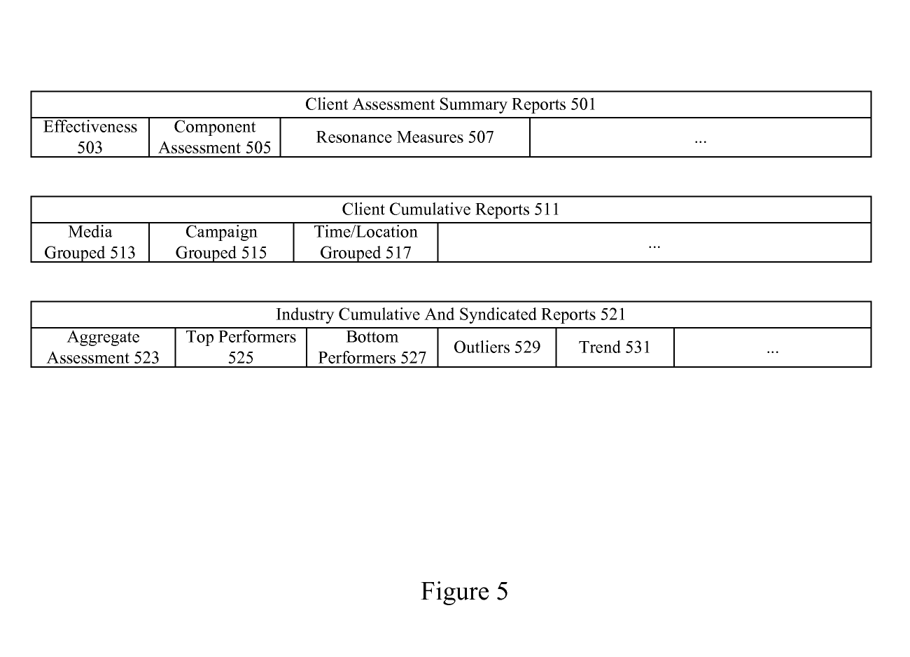

FIG. 5 illustrates examples of reports that can be generated. According to various embodiments, client assessment summary reports 501 include effectiveness measures 503, component assessment measures 505, and resonance measures 507. Effectiveness assessment measures include composite assessment measure(s), industry/category/client specific placement (percentile, ranking, etc.), actionable grouping assessment such as removing material, modifying segments, or fine tuning specific elements, etc, and the evolution of the effectiveness profile over time. In particular embodiments, component assessment reports include component assessment measures like attention, emotional scores, percentile placement, ranking, etc. Component profile measures include time based evolution of the component measures and profile statistical assessments. According to various embodiments, reports include the number of times material is assessed, attributes of the multiple presentations used, evolution of the response assessment measures over the multiple presentations, and usage recommendations.

According to various embodiments, client cumulative reports 511 include media grouped reporting 513 of all stimulus assessed, campaign grouped reporting 515 of stimulus assessed, and time/location grouped reporting 517 of stimulus assessed. According to various embodiments, industry cumulative and syndicated reports 521 include aggregate assessment responses measures 523, top performer lists 525, bottom performer lists 527, outliers 529, and trend reporting 531. In particular embodiments, tracking and reporting includes specific products, categories, companies, brands.

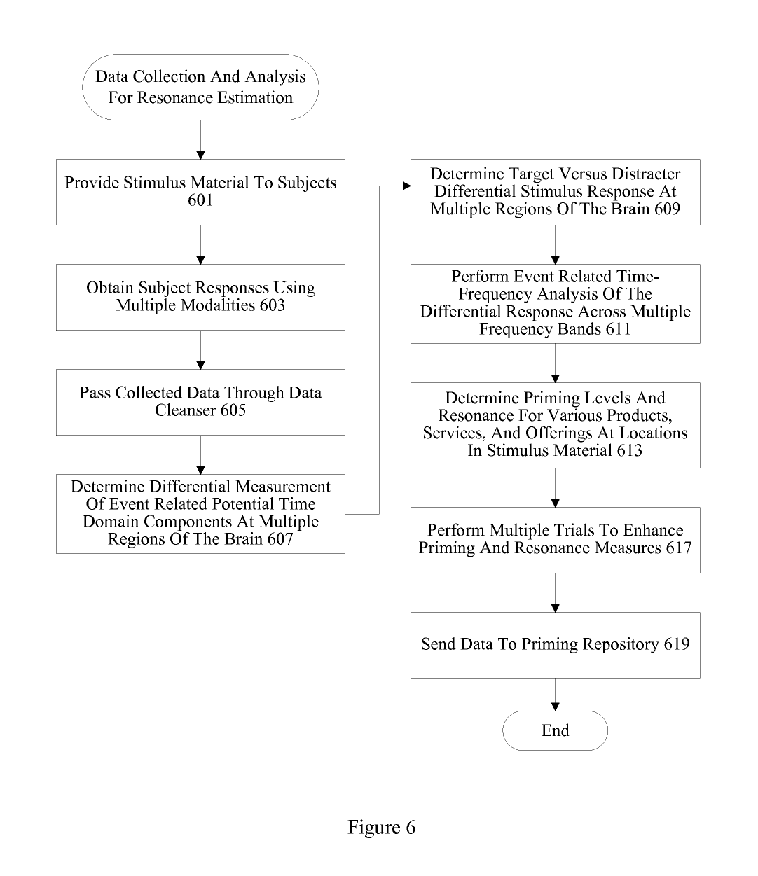

FIG. 6 illustrates one example of evaluating materials for an advoacy as advertisement system. Although priming characteristics are described, it should be noted that other neuro-response characteristics such as retention, engagement, resonance, etc., may also be obtained. At 601, stimulus materials including advocacy materials are provided to multiple subjects. According to various embodiments, stimulus includes streaming video and audio. In particular embodiments, subjects view stimulus in their own homes in group or individual settings. In some examples, verbal and written responses are collected for use without neuro-response measurements. In other examples, verbal and written responses are correlated with neuro-response measurements. At 603, subject neuro-response measurements are collected using a variety of modalities, such as EEG, ERP, EOG, FMRI, etc. At 605, data is passed through a data cleanser to remove noise and artifacts that may make data more difficult to interpret. According to various embodiments, the data cleanser removes EEG electrical activity associated with blinking and other endogenous/exogenous artifacts.

According to various embodiments, data analysis is performed. Data analysis may include intra-modality response synthesis and cross-modality response synthesis to enhance effectiveness measures. It should be noted that in some particular instances, one type of synthesis may be performed without performing other types of synthesis. For example, cross-modality response synthesis may be performed with or without intra-modality response synthesis. In other examples, intra-modality response synthesis may be performed without cross-modality response synthesis.

A variety of mechanisms can be used to perform data analysis. In particular embodiments, a stimulus attributes repository is accessed to obtain attributes and characteristics of the stimulus materials, along with purposes, intents, objectives, etc. In particular embodiments, EEG response data is synthesized to provide an enhanced assessment of effectiveness. According to various embodiments, EEG measures electrical activity resulting from thousands of simultaneous neural processes associated with different portions of the brain. EEG data can be classified in various bands. According to various embodiments, brainwave frequencies include delta, theta, alpha, beta, and gamma frequency ranges. Delta waves are classified as those less than 4 Hz and are prominent during deep sleep. Theta waves have frequencies between 3.5 to 7.5 Hz and are associated with memories, attention, emotions, and sensations. Theta waves are typically prominent during states of internal focus.

Alpha frequencies reside between 7.5 and 13 Hz and typically peak around 10 Hz. Alpha waves are prominent during states of relaxation. Beta waves have a frequency range between 14 and 30 Hz. Beta waves are prominent during states of motor control, long range synchronization between brain areas, analytical problem solving, judgment, and decision making. Gamma waves occur between 30 and 60 Hz and are involved in binding of different populations of neurons together into a network for the purpose of carrying out a certain cognitive or motor function, as well as in attention and memory. Because the skull and dermal layers attenuate waves in this frequency range, brain waves above 75-80 Hz are difficult to detect and are often not used for stimuli response assessment.

However, the techniques and mechanisms of the present invention recognize that analyzing high gamma band (kappa-band: Above 60 Hz) measurements, in addition to theta, alpha, beta, and low gamma band measurements, enhances neurological attention, emotional engagement and retention component estimates. In particular embodiments, EEG measurements including difficult to detect high gamma or kappa band measurements are obtained, enhanced, and evaluated. Subject and task specific signature sub-bands in the theta, alpha, beta, gamma and kappa bands are identified to provide enhanced response estimates. According to various embodiments, high gamma waves (kappa-band) above 80 Hz (typically detectable with sub-cranial EEG and/or magnetoencephalography) can be used in inverse model-based enhancement of the frequency responses to the stimuli.

Various embodiments of the present invention recognize that particular sub-bands within each frequency range have particular prominence during certain activities. A subset of the frequencies in a particular band is referred to herein as a sub-band. For example, a sub-band may include the 40-45 Hz range within the gamma band. In particular embodiments, multiple sub-bands within the different bands are selected while remaining frequencies are band pass filtered. In particular embodiments, multiple sub-band responses may be enhanced, while the remaining frequency responses may be attenuated.

An information theory based band-weighting model is used for adaptive extraction of selective dataset specific, subject specific, task specific bands to enhance the effectiveness measure. Adaptive extraction may be performed using fuzzy scaling. Stimuli can be presented and enhanced measurements determined multiple times to determine the variation profiles across multiple presentations. Determining various profiles provides an enhanced assessment of the primary responses as well as the longevity (wear-out) of the marketing and entertainment stimuli. The synchronous response of multiple individuals to stimuli presented in concert is measured to determine an enhanced across subject synchrony measure of effectiveness. According to various embodiments, the synchronous response may be determined for multiple subjects residing in separate locations or for multiple subjects residing in the same location.

Although a variety of synthesis mechanisms are described, it should be recognized that any number of mechanisms can be applied—in sequence or in parallel with or without interaction between the mechanisms.

Although intra-modality synthesis mechanisms provide enhanced significance data, additional cross-modality synthesis mechanisms can also be applied. A variety of mechanisms such as EEG, eye tracking, FMRI, EOG, and facial emotion encoding are connected to a cross-modality synthesis mechanism. Other mechanisms as well as variations and enhancements on existing mechanisms may also be included. According to various embodiments, data from a specific modality can be enhanced using data from one or more other modalities. In particular embodiments, EEG typically makes frequency measurements in different bands like alpha, beta and gamma to provide estimates of significance. However, the techniques of the present invention recognize that significance measures can be enhanced further using information from other modalities.

For example, facial emotion encoding measures can be used to enhance the valence of the EEG emotional engagement measure. EOG and eye tracking saccadic measures of object entities can be used to enhance the EEG estimates of significance including but not limited to attention, emotional engagement, and memory retention. According to various embodiments, a cross-modality synthesis mechanism performs time and phase shifting of data to allow data from different modalities to align. In some examples, it is recognized that an EEG response will often occur hundreds of milliseconds before a facial emotion measurement changes. Correlations can be drawn and time and phase shifts made on an individual as well as a group basis. In other examples, saccadic eye movements may be determined as occurring before and after particular EEG responses. According to various embodiments, time corrected FMRI measures are used to scale and enhance the EEG estimates of significance including attention, emotional engagement and memory retention measures.

Evidence of the occurrence or non-occurrence of specific time domain difference event-related potential components (like the DERP) in specific regions correlates with subject responsiveness to specific stimulus. According to various embodiments, ERP measures are enhanced using EEG time-frequency measures (ERPSP) in response to the presentation of the marketing and entertainment stimuli. Specific portions are extracted and isolated to identify ERP, DERP and ERPSP analyses to perform. In particular embodiments, an EEG frequency estimation of attention, emotion and memory retention (ERPSP) is used as a co-factor in enhancing the ERP, DERP and time-domain response analysis.

EOG measures saccades to determine the presence of attention to specific objects of stimulus. Eye tracking measures the subject's gaze path, location and dwell on specific objects of stimulus. According to various embodiments, EOG and eye tracking is enhanced by measuring the presence of lambda waves (a neurophysiological index of saccade effectiveness) in the ongoing EEG in the occipital and extra striate regions, triggered by the slope of saccade-onset to estimate the significance of the EOG and eye tracking measures. In particular embodiments, specific EEG signatures of activity such as slow potential shifts and measures of coherence in time-frequency responses at the Frontal Eye Field (FEF) regions that preceded saccade-onset are measured to enhance the effectiveness of the saccadic activity data.

According to various embodiments, facial emotion encoding uses templates generated by measuring facial muscle positions and movements of individuals expressing various emotions prior to the testing session. These individual specific facial emotion encoding templates are matched with the individual responses to identify subject emotional response. In particular embodiments, these facial emotion encoding measurements are enhanced by evaluating inter-hemispherical asymmetries in EEG responses in specific frequency bands and measuring frequency band interactions. The techniques of the present invention recognize that not only are particular frequency bands significant in EEG responses, but particular frequency bands used for communication between particular areas of the brain are significant. Consequently, these EEG responses enhance the EMG, graphic and video based facial emotion identification.

According to various embodiments, post-stimulus versus pre-stimulus differential measurements of ERP time domain components in multiple regions of the brain (DERP) are measured at 607. The differential measures give a mechanism for eliciting responses attributable to the stimulus. For example the messaging response attributable to an advertisement or the brand response attributable to multiple brands is determined using pre-resonance and post-resonance estimates

At 609, target versus distracter stimulus differential responses are determined for different regions of the brain (DERP). At 611, event related time-frequency analysis of the differential response (DERPSPs) is used to assess the attention, emotion and memory retention measures across multiple frequency bands. According to various embodiments, the multiple frequency bands include theta, alpha, beta, gamma and high gamma or kappa. At 613, priming levels and resonance for various products, services, and offerings are determined at different locations in the stimulus material. In some examples, priming levels and resonance are manually determined. In other examples, priming levels and resonance are automatically determined using neuro-response measurements. According to various embodiments, video streams are modified with different inserted advertisements for various products and services to determine the effectiveness of the inserted advertisements based on priming levels and resonance of the source material.

At 617, multiple trials are performed to enhance priming and resonance measures. In particular embodiments, the priming and resonance measures are sent to a priming repository 619. The priming repository 619 may be used to automatically select and place advertising suited for particular slots in a cluster. Advertisements may be automatically selected and arranged in advertisement slots to increase effectiveness.

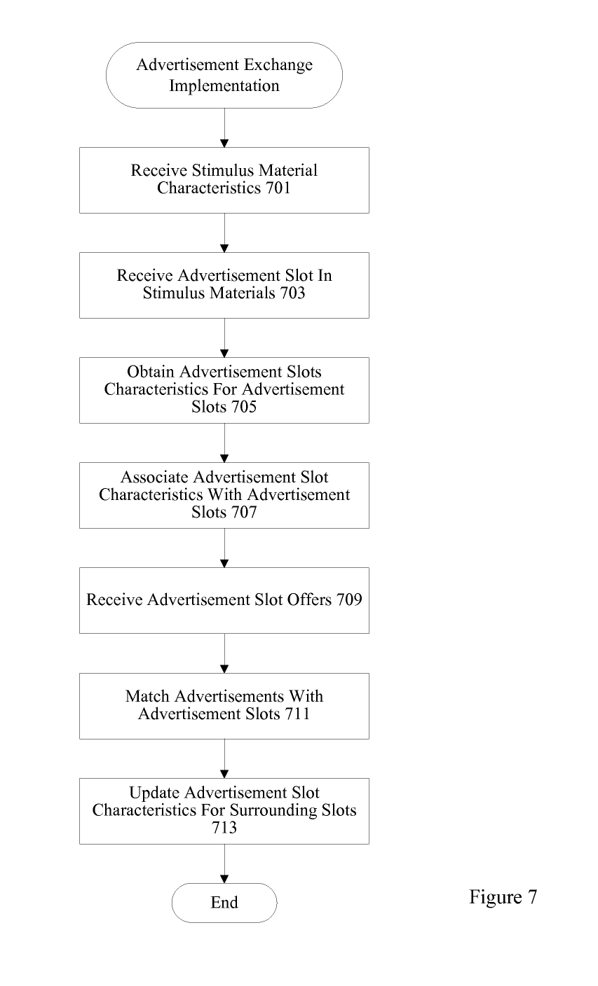

FIG. 7 illustrates an example of a technique for implementing an advocacy as advertisement system. At 701, profile characteristic information is received from a user in a social networking environment. Profile characteristic information may include age, gender, interests, activities, group associations, location, income level, etc, of the user and members of the user's social network. At 703, brand, product, offer, service, etc., data is received from an advocacy source such as a company, advertiser, individual, or firm. The advocacy source may specify characteristics desired in an advocate. Alternatively, the advocacy source may allow an advocacy system to identify advocates most appropriate based on analysis of the subject of advocacy. In particular embodiments, analysis may involve evaluating neuro-response data from various groups of advocates having a particular set of characteristics and the subject of advocacy.

At 705, users are matched to subjects of advocacy. In some examples, users select subjects of advocacy or companies select advocates. In other examples, matching is done based on identification of user characteristics including interests. At 707, advocacy materials are generated. The user may generate advocacy materials or the advocacy materials may be automatically generated. In particular embodiments, generating advocacy materials may involve selecting neurophsyiologically analyzed advocacy components. At 709, generated advocacy materials are combined with user materials. At 711, compensation for advocates is tracked. According to various embodiments, a compensation tracker monitors the distribution of advocacy materials, follow-up advocacy materials, and redistribution of the advocacy materials by members of an advocate's social network. The number of redistributions may be used to identify the number of credits to be provided to the advocate. In other examples, the number of social network members who indicate that the advocacy is valued or liked is monitored. In still other examples, the number of social network members who accept an offer or purchase a good or service is monitored in order to compensate the advocate. At 713, advocacy materials are distributed using social networking channels.

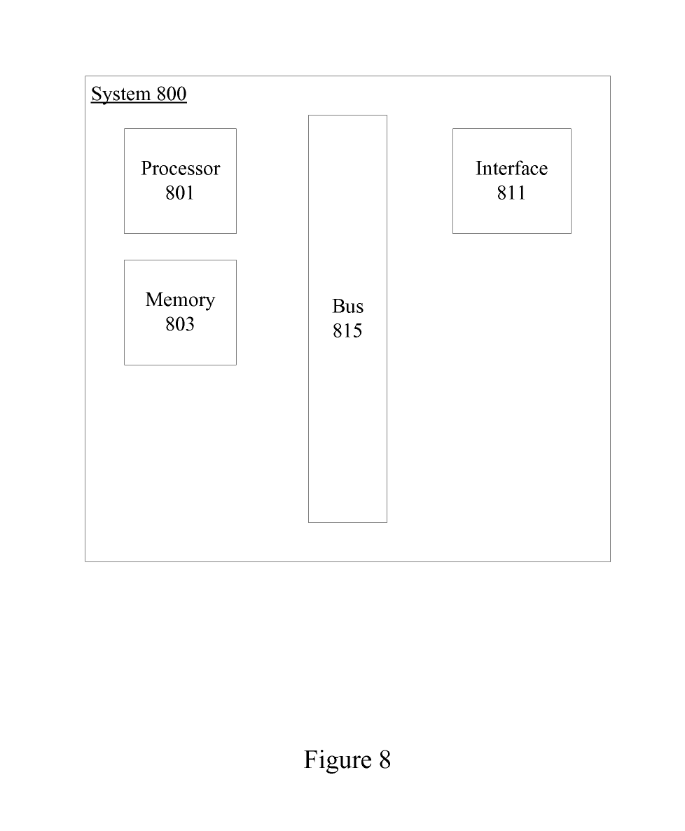

According to various embodiments, various mechanisms such as the data collection mechanisms may be implemented on multiple devices. However, it is also possible that the various mechanisms be implemented in hardware, firmware, and/or software in a single system. FIG. 8 provides one example of a system that can be used to implement one or more mechanisms. For example, the system shown in FIG. 8 may be used to implement a system.

According to particular example embodiments, a system 800 suitable for implementing particular embodiments of the present invention includes a processor 801, a memory 803, an interface 811, and a bus 815 (e.g., a PCI bus). When acting under the control of appropriate software or firmware, the processor 801 is responsible for tasks such as pattern generation. Various specially configured devices can also be used in place of a processor 801 or in addition to processor 801. The complete implementation can also be done in custom hardware. The interface 811 is typically configured to send and receive data packets or data segments over a network. Particular examples of interfaces the device supports include host bus adapter (HBA) interfaces, Ethernet interfaces, frame relay interfaces, cable interfaces, DSL interfaces, token ring interfaces, and the like.

According to particular example embodiments, the system 800 uses memory 803 to store data, algorithms and program instructions. The program instructions may control the operation of an operating system and/or one or more applications, for example. The memory or memories may also be configured to store received data and process received data.

Because such information and program instructions may be employed to implement the systems/methods described herein, the present invention relates to tangible, machine readable media that include program instructions, state information, etc. for performing various operations described herein. Examples of machine-readable media include, but are not limited to, magnetic media such as hard disks, floppy disks, and magnetic tape; optical media such as CD-ROM disks and DVDs; magneto-optical media such as optical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A system, comprising:
a processor configured to analyze profile characteristic information associated with a user having an associated social network, map the user to a subject of advocacy using profile characteristic information, and generate advocacy materials using profile characteristic information;
an interface configured to transmit advocacy materials to the user for distribution through the social network associated with the user;
wherein distribution and redistribution of the advocacy materials through the social network is monitored to provide remuneration to the user.

2. The system of claim 1, wherein profile characteristic information includes ages and interests of members of the social network.

3. The system of claim 1, wherein profile characteristic information includes gender, age, location, and ethnicity of the user and members of the social network associated with the user.

4. The system of claim 1, wherein the subject of advocacy is a brand, product, and/or offer.

5. The system of claim 1, wherein the user is mapped to the subject of advocacy by evaluating neuro-response data from various groups of individuals exposed to various subjects of advocacy.

6. The system of claim 1, wherein the neuro-response data includes electroencephalography (EEG) data.

7. The system of claim 1, wherein advocacy materials are generated by users.

8. The system of claim 1, wherein advocacy materials are automatically generated by aggregating materials from other users.

9. A method, comprising:
analyzing profile characteristic information associated with a user having an associated social network;
mapping the user to a subject of advocacy using profile characteristic information;
generating advocacy materials using profile characteristic information;
transmitting advocacy materials to the user for distribution through the social network associated with the user;
monitoring distribution and redistribution of the advocacy materials through the social network to provide remuneration to the user.

10. The method of claim 9, wherein profile characteristic information includes ages and interests of members of the social network.

11. The method of claim 9, wherein profile characteristic information includes gender, age, location, and ethnicity of the user and members of the social network associated with the user.

12. The method of claim 9, wherein the subject of advocacy is a brand, product, and/or offer.

13. The method of claim 9, wherein the user is mapped to the subject of advocacy by evaluating neuro-response data from various groups of individuals exposed to various subjects of advocacy.

14. The method of claim 9, wherein the neuro-response data includes electroencephalography (EEG) data.

15. The method of claim 9, wherein advocacy materials are generated by users.

16. The method of claim 9, wherein advocacy materials are automatically generated by aggregating materials from other users.

17. An apparatus, comprising:
means for analyzing profile characteristic information associated with a user having an associated social network;
means for mapping the user to a subject of advocacy using profile characteristic information;
means for generating advocacy materials using profile characteristic information;
means for transmitting advocacy materials to the user for distribution through the social network associated with the user;
means for monitoring distribution and redistribution of the advocacy materials through the social network to provide remuneration to the user.

18. The apparatus of claim 17, wherein profile characteristic information includes ages and interests of members of the social network.

19. The apparatus of claim 17, wherein profile characteristic information includes gender, age, location, and ethnicity of the user and members of the social network associated with the user.

20. The apparatus of claim 17, wherein the subject of advocacy is a brand, product, and/or offer.
